(19) United States
(12) Patent Application Publication
(10) Pub. No.: US 2022/0401303 A1
(43) Pub. Date: Dec. 22, 2022

(54) Personalized Medicament Delivery Product

(71) Applicant: Xerox Corporation, Norwalk, CT (US)

(72) Inventors: Chu-heng Liu, Penfield, NY (US); Jason M. LeFevre, Penfield, NY (US); Paul J. McConville, Webster, NY (US); Seemit Praharaj, Webster, NY (US); Douglas K. Herrmann, Webster, NY (US)

(21) Appl. No.: 17/350,356

(22) Filed: Jun. 17, 2021

(51) Int. Cl. A61J 3/07; A61J 3/06; A61J 3/00; A23P 20/18; A23P 20/20

(52) U.S. Cl. CPC A61J 3/07; A61J 3/06; A61J 3/005; A23P 20/18; A23P 20/20; A23P 2020/253

(57) ABSTRACT

A medicament delivery product is provided in which one or more medicaments are fixed on a sheet according to a patient-specific pre-defined pattern. The sheet is formed into a three-dimensional or non-planar shape to facilitate ingestion by the patient. The pre-defined patterns for the medicaments are configured for controlled release or absorption of the corresponding medicament after ingestion by the patient. The medicaments can be in a liquid or a powder form and applied to the surface of the sheet in an appropriate manner. The one or more medicaments can be any combination of drugs, medicines, vitamins, nutritional supplements and the like.

### TECHNICAL FIELD

This disclosure relates to the field of drug or medicine delivery in the form of capsules or pills. The disclosure further relates to controlled release of the drug or medicine in the capsule or pill.

### BACKGROUND

Many drugs, medicaments, such as drugs, nutritional supplements, vitamins or other medicines, are provided to patients in the form of fixed dosage carriers, such as capsules, caplets, tablets or pills. For instance, over-the-counter pain relievers are often provided in fixed dosage caplets with instructions to take one or more caplets depending on the patient's age, weight and medical condition. A similar approach is often taken with respect to prescription medicaments in which a number of fixed dosage medicament carriers are prescribed to come as close to an optimal dosage as possible for the patient. In some cases, it is necessary for the patient to break apart a fixed dosage pill in order to obtain the prescribed dosage.

The use of fixed dosage medicament carriers generally only allows for an approximation of an optimal dosage of a medicament for a particular patient. Various factors go into determining an optimal dosage, including the age and physical characteristics of the patient, as well as the nature of other medicaments being taken by the patient. In addition, the assimilation characteristics of the medicament after ingestion by the patient and the potential interaction of multiple medicaments being taken by the patient are considerations in determining an optimal dosage and ingestion plan.

For many patients, the optimal dosage of a particular medicament is not a multiple of the available fixed dosage carriers. For example, a particular drug may be provided in 5 mg pills, whereas the optimal dosage for a particular patient may be 11 mg of the drug. Two 5 mg pills provide less than optimal dosage, while three of the 5 mg pills are too much.

Some medications need to be absorbed quickly or all at once to achieve the desired function. On the other hand, many other medications require slower introduction into the patient's circulatory system. This enables a sustained or delayed action within the body, making sure that the patient does not get too much of the medicament at once or does not get a sufficient quantity of the medication right away. Timed-release of medications allow medication to provide a uniform effect on the patient ntil the last amount of medication has been absorbed and processed by the body.

Consequently, there is a need for a method and medicament delivery product that allows for precision dosage and controlled release of the medicament. The dosage can be personalized to a particular patient and can be readily adjusted as needed for precise dosage control.

### SUMMARY OF THE DISCLOSURE

A personalized dosage medicament product comprises a sheet composed of an edible and/or pharmaceutically-compatible material, and one or more medicaments fixed to a first surface of said substrate or sheet, each of said one or more medicaments fixed in a patient-specific pre-defined pattern. The medicaments can be different drugs, medicines, vitamins, nutritional supplements and the like. The pre-determined pattern for each medicament is patient-specific according to a prescription for the patient, taking into account dosage and absorption rates for the particular medicament.

In one feature of the present disclosure, a method for producing a medicament delivery product ingestible by a patient is provided that comprises the steps of providing a sheet composed of an edible and/or pharmaceutically-compatible material, providing a plurality of medicaments, and applying each of the plurality of medicaments onto a first surface of the sheet according to a patient-specific pre-defined pattern for each of the plurality of medicaments. The medicaments are fixed on the first surface of the sheet for subsequent absorption by the patient when the medicament is ingested.

The method can further include the step of manipulating the medicament product into a non-planar or three-dimensional form to facilitate ingestion by the patient. The three-dimensional form in combination with the pre-defined patterns of the medicaments provides a controlled release or absorption of the corresponding medicament as the underlying substrate or sheet dissolves.

The method of the present disclosure further contemplates applying a medicament in a liquid form or a powder form onto the sheet. The sheet can be a continuous sheet fed through a series of stations in which the medicament is deposited on the substrate or sheet and subsequently fixed on the sheet. In a post-processing station, the continuous sheet can be cut into a plurality of discrete medicament delivery products according to the prescription of a particular patient. According to this method, the pattern of medicaments can be designed according to a patient-specific prescription, which prescription can be stored in a memory for use by a controller to control the stations configured to feed the substrate, deposit the medicaments fix the medicaments on the substrate and post-process the sheet or substrate.

The method and product of the present disclosure provides a medicament delivery product that is tailored to a specific patient. The method and process allows for any quantity of finished delivery product to be produced according to the patient prescription and for ready change from the prescription for one patient to the prescription for a different patient. Any number of medicaments can be fixed to the substrate and manipulated into a form that is readily ingestible by the patient. The method and product further allow for pre-determined timing and sequence of release of one or more medications in a single ingestible product.

### DESCRIPTION OF THE DRAWINGS

FIG. 1 is a top plan view of a personalized medicament delivery product according to the present disclosure.

FIG. 2 is a side cross-sectional view of the delivery product shown in FIG. 1

FIG. 3 is a top plan view of a personalized medicament delivery product according to a further embodiment of the present disclosure.

FIG. 4 is a side view of the delivery product shown in FIG. 3.

FIG. 5 is a top view of the delivery products of FIGS. 1 and 3 rolled into a cylindrical configuration.

FIG. 6 is a diagram of a process for preparing a personalized medicament delivery product according to the present disclosure.

FIG. 7 is a diagram of another process for preparing a personalized medicament delivery product according to the present disclosure.

FIG. 8 is a flowchart of a process for producing a personalized medicament delivery product according to the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

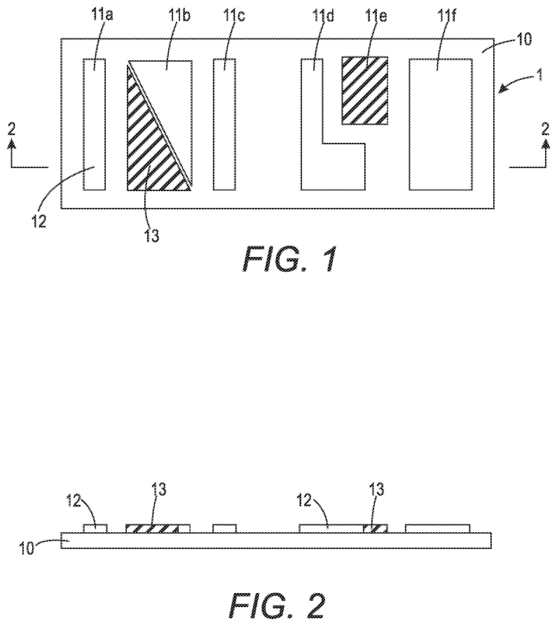

A medicament delivery system 1 is shown in FIGS. 1-2. The system 1 includes a substrate 10 formed of an edible or pharmaceutically-compatible media that is suitable for ingestion by a patient for delivering medicine, drugs, nutritional supplements, vitamins and other medicaments to the patient. By way of example, the substrate can be composed of a gelatin, such as a collagen-based gelatin, to can be composed of a cellulose material derived from plants, such as hydroxypropyl methyl cellulose (HPMC). The substrate 10 is provided as a sheet that can be manipulated and processed, such by cutting, rolling and folding. The substrate 10 is appropriately dimensioned so that the delivery system can be manipulated or processed to form a three-dimensional (3D) structure that can be orally ingested by the patient. In certain examples, the substrate can have a width of 1-3 cm. The length of the substrate can vary depending on the amount of medicament to be delivered by the system 1 and on the final 3D form of the system. For instance, as described herein, the substrate can be rolled to adopt a generally cylindrical form. The diameter of the cylindrical form is calibrated for oral ingestion, which can be 0.3-1.2 cm in certain embodiments. This diameter is a function of the thickness and length of the substrate. In one example, the thickness of the substrate can be 0.05-0.2 cm and the length can be 3-10 cm. (It is noted that the thicknesses in the drawings have been exaggerated for clarity).

In accordance with the present disclosure, one or more medicaments are applied to or “printed” on the substrate 10. In certain embodiments, the one or more medicaments can be applied in a pre-defined pattern on the substrate that is personalized to the particular patient. Thus, in the example shown in FIG. 1, two medicaments 12 and 13 are applied to the substrate in a pattern with six distinct segments 11a -11f. In the illustrated example, the first segment 11a consists only of medicament 12, while the second segment 11b includes both medicaments 12, 13 side-by-side. The first medicament 12 is provided in segments 11c, 11d and 11f, while the second medicament 13 is provided in segment 11e. It can be appreciated that each segment provides a pre-defined quantity of the respective medicament, with the total quantity of each medicament on the substrate 10 corresponding to a desired dosage of the medicaments for the particular patient.

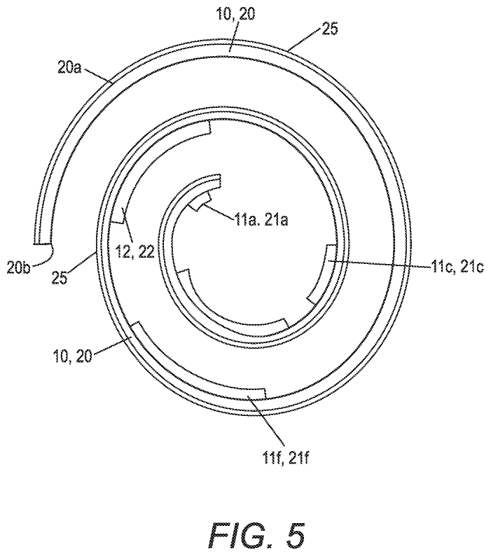

It can be appreciated that the entire surface of the substrate 10 can be covered with one medicament, such as medicament 12, or with multiple medicaments provide side-by-side along the length or width of the entire substrate 10. However, in the illustrated embodiment, the medicaments are provided in a pattern of segments 11a -11f configured to control the timing and sequence of release of the medicaments in each segment. In one embodiment, the substrate 10 is rolled into a cylindrical configuration, as shown in the top view of FIG. 5. FIG. 5 shows the medicament delivery product 1 loosely wound or rolled for clarity, but it is understood that the substrate 10 would be wound as tightly as possible to reduce the outer diameter of the device in the cylindrical configuration. With the device 1 and substrate 10 wound as depicted in FIG. 5, the segment 11f is on the outermost region of the cylindrically wound device 1. In one preferred embodiment, the wound layers are not constrained or adhered together so that when the patient ingests the device 1 the loosely wound layers quickly unwind, thereby exposing the entire surface with all of the printed medicaments substantially simultaneously. In this embodiment, the medications printed on the device are quickly released, with the speed of release being increased because the medicaments are printed on a large surface area that is quickly exposed to digestion by the stomach.

In one embodiment, the delivery product 1 can be rolled or wound into a cylindrical configuration as shown in FIG. 5. Alternatively, the delivery product 1 can be manipulated into any other configuration that facilitates ingestion by the patient. Thus, although most medications are ingested by swallowing, some medicaments are absorbed by placing under the tongue and some are absorbed rectally. The delivery products of the present disclosure can be manipulated and re-configured from the planar configuration shown in FIG. 1 to any configuration that facilitates absorption of the medicaments by the patient in any manner. the reconfigured delivery product 1 can be encapsulated in a coating to protect the medicaments and/or facilitate ingestion of the device. It is also contemplated that the delivery product 1 can be manipulated to be placed within a capsule or caplet.

In an alternative embodiment, a delivery product 2 is configured to be, in essence, self-contained. Thus, the device 2 includes a substrate 20 that can be formed of the edible or pharmaceutically-compatible materials described above with respect to substrate 10. The medicaments 22, 23 can be applied in essentially the same pattern of segments 21a -21f as the segments 11a -11f. In one modification, best shown in FIG. 4, the segment 21b can include the medicament 22 overlaying part of the medicament 23. As discussed above, the pattern of medicaments applied to the substrate 20 can be tailored to the particular patient. It is thus contemplated that in certain dosing protocols a patient requires simultaneous ingestion of two medicaments, such as the medicaments 22, 23 in segment 21b. In other segments, the two medicaments are isolated, such as in segments 21d and 21e.

The delivery product 2 includes a segment 21g at one end of the substrate 20 that does not include any medicament. The bottom surface 20b of the substrate 20, opposite the upper surface 20a with the segments 21a -21f, is provided with an adhesive layer 25. The adhesive layer covers substantially the entire bottom surface 20b of the substrate 20. The adhesive layer 25 comprises an adhesive capable of adhering to the upper surface 20a so that the substrate 20 can be rolled up as shown in FIG. 5. In the embodiment shown in FIG. 5, the delivery product 2 is rolled or wound with the adhesive layer 25 exposed on the outside of the cylindrical formed device. Alternatively, the substrate can be wound in the opposite direction with the adhesive layer 25 hidden and the bottom surface 20b of the substrate exposed. In either case, the adhesive layer will adhere to the top surface 20a to hold the cylindrical configuration of the substrate 20. Rather than being rolled or wound, the substrate can be folded over onto itself, in which case the adhesive layer 25 performs the same function of holding the manipulated configuration of the delivery product together. The adhesive layer is composed of an edible or pharmaceutically-compatible adhesive or glue composition, such as a starch, cellulose or organic acid-based composition, which is capable of adhering to the material of the substrate 20.

The segment 21g of the pattern on the substrate 20 does not include any medicament.

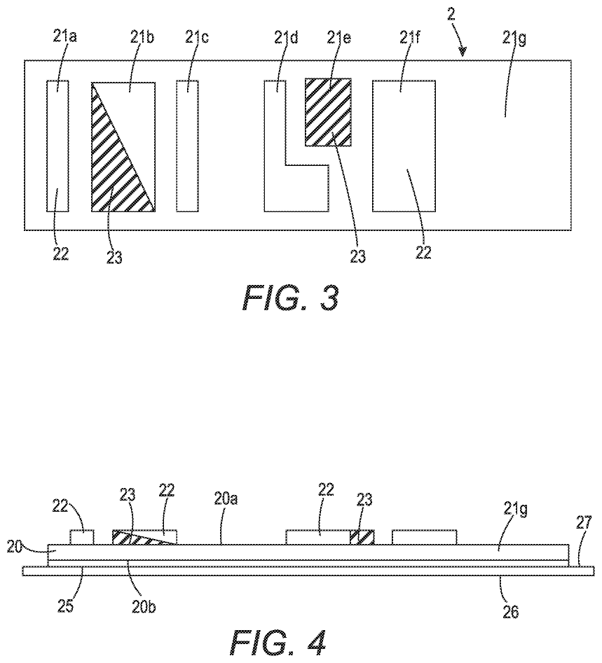

The segment 21g has a length sufficient to completely encircle or encase the medicament-bearing segments of the substrate when the substrate is rolled or wound into the cylindrical configuration shown in FIG. 5. In other words, the segment 21g acts as a covering for the 3D form of the delivery product 2. In some embodiments, the delivery product 2 can be provided to the patient or pharmacist already in the cylindrical configuration. In other embodiments, the delivery product 2 can be provided to the patient or pharmacist as shown in FIGS. 3-4—i.e., in a planar or sheet format. In this case, the device is provided with a liner 26 covering the adhesive layer 25. The patient or pharmacist can remove or peel off the liner 26 to expose the adhesive layer, and then manually manipulate the device 2 into a form that can be ingested by the patient. Nominally, the patient or pharmacist would roll the substrate up into the cylindrical form shown in FIG. 5 so that the delivery product 2 emulates a conventional pill or capsule.

The adhesive layer 25 offers a convenient way to roll or pack the medication delivery product 2. In addition, the adhesive or glue can be selected so that it is not readily dissolvable when ingested. This characteristic of the adhesive can prevent the quick un-winding of the packed/rolled medication structure, thereby providing a precision-controlled release of the medications originally printed on the planner substrate. Once the patient ingests the device 1, wound as shown in FIG. 5, the stomach starts digesting the pill. The exposed portion of the substrate 10 is digested, exposing the segments 11f for digestion. The adjacent segments 11e and 11f are digested next as the outer portion of the substrate is removed. The segments 11a -11c are subsequently absorbed as the digestion continues radially inward for the cylindrically formed device 1.

It can be appreciated that the pattern segments of medicaments 11a -11f, 21a -21f described above can be for one or more medicaments, such as medicines and drugs. For instance, a particular pattern of a single medicament can be provided on the delivery product 1, 2 to establish a pre-determined release and absorption sequence, such as a time-release feature for the medicament. It is contemplated that the substrate 10, 20 dissolves at a known rate to expose the medicament deposited on the substrate, and this known rate can be used to provide for precision delivery of the medicament to the patient. The rate of delivery can be adjusted by rolling the product 1, 2, as illustrated in FIG. 5 so that the delivery product dissolves from the outside to the interior. As each layer is dissolved and absorbed, the medicament pattern segments are exposed. The delivery rate can be further adjusted by establishing pre-determined spacing between the pattern segments so that there is more or less substrate material to be dissolved or absorbed before the underlying medicaments are exposed for absorption. The rate of delivery and dosage of the medicament(s) can also be determined by the thickness of the medicament layer on the substrate. For instance, some of the segments of the pattern can have a thicker layer of medicament than others to provide a precise drug delivery protocol. The pattern of the segments 11a -11f, 21a -21f are exemplary and can have other forms for one or more medicaments. The pattern can be customized for each patient based on factors that determine the patient's ability to assimilate each of the medicaments and on details of the particular prescription for the medicament.

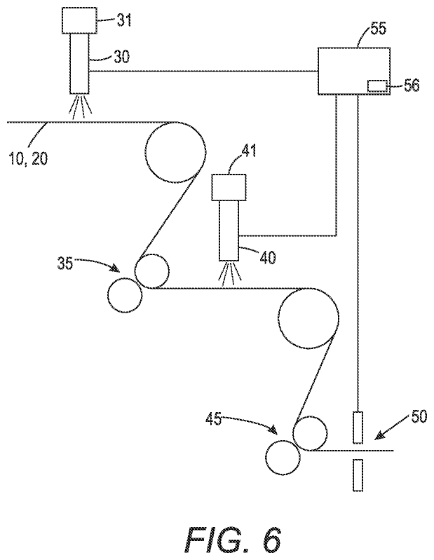

The patterns of medicaments 11a -11f, 21a -21f are deposited on the substrate 10, 20 in a manner suitable to the particular medicament(s). FIG. 6 is a schematic representation of a system and process for depositing a liquid-based medicament on a substrate 10, 20. In particular, a first controllable liquid deposition station 30 is provided to deposit a first liquid medicament onto the substrate 10, 20 as the substrate is conveyed beneath the device. The substrate can be conveyed in a conventional manner for sheet media, such as by using an array of driven rollers and guide rollers. It can be appreciated that the first liquid medicament can be a medicament that is already in a liquid form capable of deposition onto the substrate, or can be a solid medicament that is dissolved or dispersed in a suitable liquid carrier that can be deposited on the substrate. In the latter case, the suitable liquid carrier can be an edible or pharmaceutically-compatible liquid, such as a solvent, or a pharmaceutically-compatible phase-change composition, such as a wax. The first liquid medicament can include other components, for example, but not limited to, coloring agents, dyes or pigments.

The deposition station 30 is configured to and capable of uniformly depositing the first liquid medicament in a pre-determined pattern across the width and along the length of the substrate as it passes beneath the device. In certain embodiments, the first liquid medication is applied at a substantially uniform thickness on the surface of the substrate. The pre-determined pattern can be unique to a particular patient, as described above. Thus, in one embodiment, the deposition station 30 includes a plurality of controllable jets or nozzles connected to a reservoir 31 containing the first liquid medicament. In specific embodiments, the deposition station can be a device used for depositing phase-change compositions onto a print substrate, in the nature of an ink-jet printer. For example, medications can be dissolved or dispersed in a phase-change carrier, such as a wax, at the deposition station, or can be dissolved or dispersed in the phase change wax that is provided to the deposition station in solid form. In embodiments utilizing a phase-change carrier, the phase change composition or wax can have a phase-change temperature between, for example, but not limited to, 40 and 200° C., or more particularly a phase-change temperature between 60 and 120° C. In some aspects, the phase change carrier can be solid at room temperature and fluid at temperatures above the phase change temperature. In some aspects, the phase change carriers can have a viscosity at jetting temperature between, for example, but not limited to, 0.5 to 50 cps, or more particularly 5 to 20 cps.

It can be appreciated that a similar ink-jet printer device can be used to deposit a medicament in liquid form without the phase-change ink. The deposition station can include a plurality of jets or nozzles extending across the width of the substrate 10, 20 and arranged to ensure that a substantially uniform layer of the first liquid medicament is applied to the substrate. The nozzles can be individually controlled to be activated to dispense the liquid medicament in a pre-determined pattern, such as the patterns described above. The nozzles can also be controlled to control the thickness of the liquid medicament layer on the substrate.

After deposition of the first medicament, the substrate 10, 20 is conveyed by rollers to a conditioning station 35 where the layer of the first liquid medicament is fixed on the substrate. In particular, the medicament can be dried and/or compacted on the substrate. The station 35 can comprise heated rollers or other components suitable to condition the medicament layer without compromising the medicament. The conditioning station 35 can also be configured to ensure that the medicament has a uniform thickness across the substrate.

If a second medicament is to be incorporated into the delivery product 1, 2, the substrate advances to a second deposition station 40 that is configured to deposit a second liquid medicament onto the substrate 10, 20 as it passes. The second deposition station 40 can be configured similar to the first deposition station 30, including nozzles or jets to direct the second liquid medicament form a second reservoir 41 onto the substrate in a controlled manner according to the pre-determined pattern. The second liquid medicament can be applied as segments separate from the first liquid medicament, as reflected in the pattern shown in FIG. 1, or overlaying or overlapping the first medicament layer, as reflected in the pattern shown in FIG. 4. After deposition of the layer of the second liquid medicament, the substrate 10, 20 advances to a second conditioning station 45 for fixing the second medicament to the substrate, similar to the station 35. It can be appreciated that although FIG. 6 only depicts two medicaments being applied to the substrate, the substrate can be advanced to further deposition stations and conditioning stations for the application of additional medicament layers, whether of the same or different medicaments.

After exiting the last conditioning station, such as station 45, the substrate 10, 20 carries the full complement of medicaments in the pre-determined pattern prescribed for the particular patient. The substrate advances to a post-processing station 50. The station 50 can include a cutting element configured to cut the substrate to form the final individual delivery products 1, 2. Alternatively, the cutting element of the post-processing station 50 can be configured to form perforations along the width of the substrate 10, 20 for a certain number of delivery products 1, 2 that can be subsequently separated by the patient. Post-processing can also include printing information on the non-medicament side of the substrate 10, 20. That information can include information regarding the medicaments in the delivery product, instructions for taking the medicaments and patient specific information. The post-processing station 50 can include a packaging element configured to package the delivery product products in sheet form or to further process the delivery products into a 3D shape, as described above. The re-formed 3D delivery product can be held or fixed in the 3D configuration by insertion into a capsule or by the introduction of a fixing element, such as a band or an adhesive. In some cases, timed-release is not required so the 3D configuration of the delivery product 1, 2 can be adapted to unroll or unfold very soon after ingestion, exposing all of the medicaments on the substrates 10, 20. In these cases, the fixing element can be configured to dissolve more quickly than the delivery product 1, 2.

The system shown in FIG. 6 can operate under the direction of a controller 55 configured and operable to control activation of the plurality of nozzles in the two deposition stations 30, 40 as well as the operation of the post-processing station 50. The controller 55 can include a microprocessor or computer operable to execute a program stored in a memory 56 and to access data stored in the memory that defines the patterns of the medicaments to be applied, as described herein.

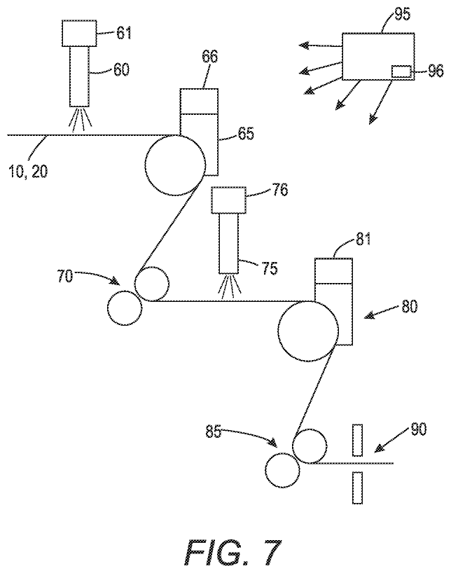

In some cases, the medicament is provided in a powder or granular form that is not susceptible to dissolved or dispersed in a liquid for nozzle deposition. FIG. 7 shows a schematic of an exemplary system and method for depositing a granular medicament onto the substrate 10, 20 to form the delivery product 1, 2. In particular, the system of FIG. 7 contemplates applying a liquid agent to the substrate in the pre-defined pattern for each specific medicament. The liquid agent is configured to attach or adhere the subsequently applied powder medicament to the substrate. Thus, the liquid agent can be an edible or pharmaceutically-compatible glue or a solvent, such as a water-based solvent, that is capable of interacting with the substrate to form a tacky surface to which the subsequent powder medicament will adhere. The liquid agent is applied to the substrate by a deposition station 60 that can be similar to the deposition stations 30, 40 described above. In particular, the deposition station 60 can include a plurality of jets or nozzles in communication with a reservoir 61 of the liquid agent, in which the nozzles are individually controllable to apply the liquid agent in the pre-defined pattern on the substrate as the substrate passes below the deposition station.

The substrate 10, 20 then passes to a powder coating station 65 that exposes the substrate, and particularly the pattern of the liquid agent, to the medicament, which is in powder or granular form and stored in a reservoir 66. The medicament will only adhere to the substrate in the pre-determined pattern and will not interact with the “un-treated” surfaces of the substrate. The powder coating station 65 is configured to apply the powder medicament in any suitable manner, with provisions to capture and/or recycle medicament that is not captured on the treated pattern. Thus, the powder medicament can be applied by direct contact between the treated pattern and the powder in the reservoir. In another embodiment, the powder can be applied by a dusting device that floods the substrate with the medication in powder form. Alternatively, the powder can be applied by a nozzle or electrostatically, as is known in the printing art. After the first powder medicament has been applied in coating station 65, the substrate passes to a conditioning station 70, which can be similar to the conditioning stations 35, 45 described above. The primary goal of the conditioning station 70 is to fix or stabilize the powder medicament on the substrate. It is contemplated that the system of FIG. 7 can be a linear process in which the substrate travels horizontally between stations. This configuration can be used where the powder medicament dispensed at the powder coating station 65 is not completely fixed to the substrate upon application. In this case, the conditioning station 70 can apply pressure, with or without heat, to fix the medicament powder to the substrate as the substrate moves horizontally to keep the powder on the substrate until it can be fixed.

If a second medicament is required for the particular delivery product 1, 2, a subsequent second deposition station 75, second reservoir 76, second powder coating station 80, second powder reservoir 81 and second conditioning station 85 can be provided that operates in the same manner as the deposition station 60 and powder coating station 65 just described. In this instance, the second medicament is also provided in powder or granular form. The system of FIG. 7 can be modified to introduce additional medicaments. Moreover, the system of FIG. 7 can be modified to deposit a liquid medicament and a powder medicament to the substrate 10, 20. Thus, the system of FIG. 7 can incorporate a deposition station like the deposition station 30 that is configured to deposit a liquid medicament onto the substrate. After the last medicament is applied, the completed substrate can proceed to a post-processing station 90 which can be configured like the post-processing station 50 described above.

The system shown in FIG. 7 can operate under the direction of a controller 95 configured and operable to control activation of the plurality of nozzles in the two deposition stations 60, 75, the powder coating stations 65, 80, as well as the operation of the post-processing station 90. The controller 95 can include a microprocessor or computer operable to execute a program stored in a memory 96 and to access data stored in the memory that defines the patterns of the medicaments to be applied, as described herein

For either system and method shown in FIGS. 6, 7, the substrate can correspond to the substrate 10 shown in the delivery product 1 of FIGS. 1-2, or can correspond to the substrate 20 shown in the delivery product 2 of FIGS. 3-4. The substrate 10 can be provided to either system on a roll and unrolled directly to the first deposition station 30, 60. The substrate 20 passes through a pre-processing station (not shown) in which the adhesive layer 25 and liner 26 are applied to a substrate 20 in a conventional manner known in the art. The completed substrate 20, with the adhesive layer and liner, pass through the two systems shown in FIGS. 6, 7 in the same manner as the substrate 10. However, it can be appreciated that some modification may be required for the conditioning stations 35, 45, 70, 85 and/or the post-processing stations 50, 90 to avoid compromising the adhesive layer and liner.

The systems shown in FIGS. 6, 7 can be used to produce several medicament delivery products 1, 2 that are tailored and specific to a particular patient. It is contemplated that the two systems can be combined to produce a medicament delivery product that includes medications in both liquid form and in solid/powder form. The deposition stations and powder coating stations can be controlled by a controller 55, 95, such as a microprocessor or a computer, which is configured to execute program instructions stored in memory 56, 96 for applying one or more medicaments to a substrate in a pre-defined pattern and in a pre-defined dosage. The controller 55, 95 can be provided with a database stored in memory in which the medicament prescription information for a plurality of patients is stored. The database can also include data for pre-defined patterns that can be used by several patients. The patient-specific information can include patient-specific pattern information or can identify one of the pre-defined patterns in the database that can be used for the patient. The patient-specific information can identify all of the medicaments prescribed to the patient as well as the exact desired dosage of those medicaments. Since the medicaments are deposited on the substrate in a controllable manner, the finished delivery product can provide the medicament in the exact desired dosage, or at least within a very small margin of error. The systems of FIGS. 6-7 can operate continuously to produce medicament delivery products 1, 2 for multiple patients by simply changing the data provided by the controller to the deposition stations, powder coating stations, conditioning stations and post-processing stations. Multiple production lines can be provided that are medicament specific. The controller 55, 95 can thus be itself controlled to identify a particular patient and/or a particular array of medicament(s) to be provided in a delivery product 1, 2.

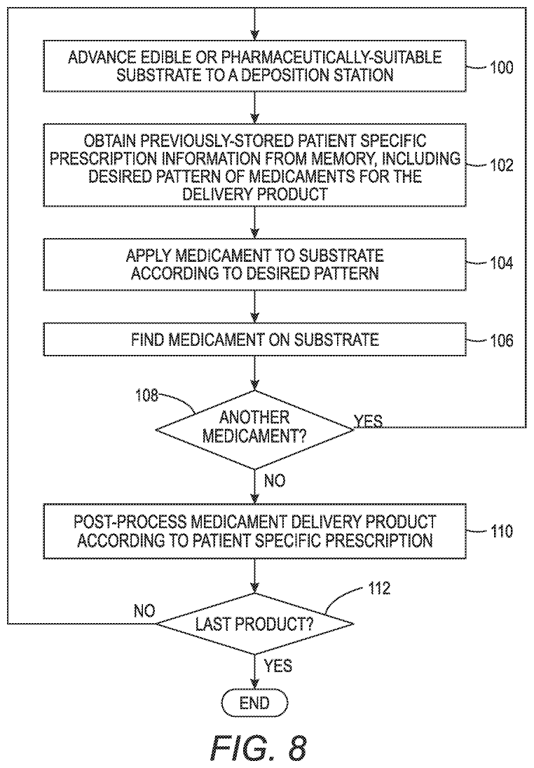

The controller 55, 95 is thus configured and operable to first advance an edible or pharmaceutically-compatible substrate to a deposition station, as in step 100 of the flowchart in FIG. 8. In step 102, the desired pattern for the particular medicament is obtained from memory and the medicament is applied in that pattern in step 104. The medicament is fixed to the substrate in step 106, as needed for the particular medicament. The controller then determines whether the patient-specific prescription requires a further medicament in the delivery product 1, 2 in step 108. If so, the substrate is advanced to the next deposition station in step 100 and the process continues to the conditional step 108. This process continues until the last medicament has been applied, after which the substrate is advanced to the post-processing stations in step 110 for processing according to the patient's prescription. As indicated above, the process of the present disclosure can produce multiple delivery products so the controller 55, 95 determines whether the last product has been produced in step 112. If not, the sequence continues for subsequent delivery products.

It is contemplated that the medicament(s) are “printed” on a substrate according to the pre-defined patient-specific pattern. This “printing” can be performed using an ink jet printer or similar device for the fluid-based medicaments discussed above. Examples of suitable ink jet devices and methods are described in U.S. Pat. No. 6,779,861, issued on Aug. 24, 2004, in U.S. Pat. No. 7,828,423, which issued on Nov. 10, 2010, and in U.S. Pat. No. 9,381,154, which issued on Jul. 5, 2016, the entire disclosures of which are incorporated herein by reference. It is known that some ink jet printers are thermal printers in which the print medium is provided in solid form and then melted prior to being dispersed by the nozzles or jets. In the present disclosure, the liquid medicament is not necessarily provided in a solid form, but is typically provided in liquid form so that there is no need to melt a solid medium. For medicaments provided in powder form, the “printing” can be performed with an electrostatic printer. Examples of a suitable electrostatic printer are described in U.S. Pat. No. 6,611,665, which issued on Aug. 26, 2003, and in U.S. Pat. No. 8,840,241, issued on Sep. 23, 2014, the entire disclosures of which are incorporated herein by reference.

The present disclosure should be considered as illustrative and not restrictive in character. It is understood that only certain embodiments have been presented and that all changes, modifications and further applications that come within the spirit of the disclosure are desired to be protected.

What is claimed is:

1. A method for producing a medicament delivery product ingestible by a patient, comprising the steps of:
providing a sheet composed of an edible and/or pharmaceutically-compatible material;
providing a plurality of medicaments;
applying each of said plurality of medicaments onto a first surface of said sheet according to a patient-specific pre-defined pattern for each of said plurality of medicaments; and
fixing each of said plurality of medicaments on the first surface of said sheet.

2. The method of claim 1, said plurality of medicaments are different from each other.

3. The method of claim 1, further comprising, after the step of fixing the last one of said plurality of medicaments, subsequently manipulating said sheet into a non-planar shape suitable for ingestion by the patient.

4. The method of claim 3, wherein:
said sheet includes a second surface opposite said first surface;
said step of subsequently manipulating said sheet includes rolling said sheet into a cylinder shape with said opposite second sheet exposed; and
then fixing the sheet in said cylinder shape.

5. The method of claim 3, wherein the step of subsequently manipulating said sheet into a non-planar shape includes folding said sheet.

6. The method of claim 1, wherein:
the step of providing a sheet includes providing a continuous sheet; and
said applying step includes continuously conveying said sheet as each of said plurality of medicaments is applied onto said first surface.

7. The method of claim 6, further comprising, after the step of fixing the last one of said plurality of medicaments, subsequently cutting said continuous sheet to form a discrete delivery product.

8. The method of claim 1, wherein:
at least one medicament of said plurality of medicaments is provided in a liquid form; and
said applying step for said at least one medicament includes applying the liquid form using a plurality of nozzles, said nozzles controllable to eject said liquid form of said at least one medicament in said pre-defined pattern for said at least one medicament.

9. The method of claim 1, wherein:
at least one medicament of said plurality of medicaments is provided in a powder form; and
said applying step for said at least one medicament includes applying the powder form onto said sheet in said pre-defined pattern for said at least one medicament.

10. The method of claim 10, wherein said powder form is applied electrostatically to said sheet.

11. The method of claim 10, wherein said applying step for said at least one medicament includes:
applying a liquid agent onto said first surface in said pre-defined pattern for said at least one medicament, said liquid agent adapted to attach or fix said powder form of said at least one medicament onto said sheet; and
then applying the powder form onto said sheet so that said powder form is attached or fixed to said sheet only in said pre-defined pattern for said at least one medicament.

12. The method of claim 1, wherein the pre-determined pattern for two or more of said plurality of medicaments include a portion where one medicament at least partially overlaps another medicament.

13. The method of claim 1, wherein:
said sheet includes a second surface opposite said first surface; and
the method further comprises the step of printing information on said second surface of said sheet.

14. The method of claim 13, wherein said information includes one or more of medicament specific information and patient specific information.

15. The method of claim 1, wherein each of said plurality of medicaments is selected from the group consisting of a drug, a medicine, a vitamin and a nutritional supplement.

16. A method for producing a medicament delivery product ingestible by a patient, comprising the steps of:
providing a sheet composed of an edible and/or pharmaceutically-compatible material;
providing a medicament;
applying the medicament onto a first surface of said sheet according to a patient-specific pre-defined pattern that is less than the entirety of said first surface; and
then fixing the medicament on the first surface of said sheet.

17. The method of claim 16, further comprising, after the step of fixing the medicament, subsequently manipulating said sheet into a non-planar shape suitable for ingestion by the patient.

18. A medicament delivery product comprising:
a sheet composed of an edible and/or pharmaceutically-compatible material; and
one or more medicaments fixed to a first surface of said sheet, each of said one or more medicaments fixed in a patient-specific pre-defined pattern that is less than the entirety of said first surface.

19. The medicament delivery product of claim 18, wherein said sheet is formed into a non-planar configuration.

20. The medicament delivery product of claim 19, wherein said non-planar configuration is a cylinder shape with a surface opposite said first surface exposed.
